(19) United States
(12) Patent Application Publication
(10) Pub. No.: US 2020/0125292 A1
(43) Pub. Date: Apr. 23, 2020

(54) MEMORY SYSTEM AND OPERATING METHOD THEREOF

(71) Applicant: SK hynix Inc., Gyeonggi-do (KR)

(72) Inventor: Eu-Joon BYUN, Gyeonggi-do (KR)

(21) Appl. No.: 16/408,735

(22) Filed: May 10, 2019

(30) Foreign Application Priority Data
Oct. 19, 2018 (KR) 10-2018-0125257

(51) Int. Cl. G06F 3/06

(52) U.S. Cl. CPC G06F 3/0659; G06F 3/0604; G06F 3/064; G06F 3/0653; G06F 3/0673; G06F 3/0652

(57) ABSTRACT

A memory system includes: a memory device including a plurality of dies; and a controller suitable for performing an idle die detection operation including detecting an idle die among the plurality of dies while performing a program operation on an open block; a subsequent open block erase operation including performing an erase operation on a subsequent open block, when a die including the subsequent open block is the detected idle die; and an open block program operation including detecting the subsequent open block as a new open block and performing the program operation on the new open block after the program operation performed on the open block is completed.

### CROSS-REFERENCE TO RELATED APPLICATION

The present application claims priority of Korean Patent Application No. 10-2018-0125257, filed on Oct. 19, 2018, which is incorporated herein by reference in its entirety.

### BACKGROUND

### 1. Field

Various embodiments of the present invention relate to a memory system, and more particularly, to a memory system capable of efficiently performing a program operation, and a method for operating the memory system.

### 2. Description of the Related Art

The computer environment paradigm has shifted to ubiquitous computing, which enables computing systems to be used anytime and anywhere. As a result, use of portable electronic devices such as mobile phones, digital cameras, and laptop computers has rapidly increased. These portable electronic devices generally use a memory system having one or more memory devices for storing data. A memory system may be used as a main memory device or an auxiliary memory device of a portable electronic device.

Memory systems provide excellent stability, durability, high information access speed, and low power consumption since they have no moving parts, as compared with a hard disk device. Examples of memory systems having such advantages include universal serial bus (USB) memory devices, memory cards having various interfaces, and solid state drives (SSDs).

### SUMMARY

Embodiments of the present invention are directed to a memory system capable of performing an erase operation on a subsequent open block while performing a program operation to an open block.

In accordance with an embodiment of the present invention, a memory system includes: a memory device including a plurality of dies; and a controller suitable for performing an idle die detection operation including detecting an idle die among the plurality of dies while performing a program operation on an open block; a subsequent open block erase operation including performing an erase operation on a subsequent open block, when a die including the subsequent open block is the detected idle die; and an open block program operation including detecting the subsequent open block as a new open block and performing the program operation on the new open block after the program operation performed on the open block is completed.

In accordance with another embodiment of the present invention, a method for operating a memory system, comprising: detecting an idle die among a plurality of dies while performing a program operation on an open block; performing an erase operation on a subsequent open block, when a die including the subsequent open block is the detected idle die; detecting the subsequent open block as a new open block; and performing the program operation on the new open block after the program operation performed on the open block is completed.

In accordance with an embodiment of the present invention, a memory system includes: a memory device including a plurality of dies; and a controller suitable for: determining a first open block for a current program operation and a second open block for a subsequent program operation; when the current program operation is performed, determining an idle die among the plurality of dies; when the idle die includes the second open block, performing an erase operation on the second open block; and performing the subsequent program operation on the erased second open block after the current program operation is completed.

### BRIEF DESCRIPTION OF THE DRAWINGS

FIG. 1 is a block diagram illustrating a data processing system including a memory system in accordance with an embodiment of the present invention.

FIG. 2 is a block diagram illustrating a concept of a super memory block used in a memory system in accordance with an embodiment of the present invention.

FIG. 3 illustrates a concept of an open block, among memory blocks,

FIG. 4 is a flowchart illustrating a conventional program operation.

FIG. 5 is a flowchart illustrating an operation of a memory system in accordance with an embodiment of the present invention.

FIG. 6 is a flowchart illustrating an erase operation performed on a subsequent open block, among memory blocks.

FIG. 7 illustrates an erase operation performed on a subsequent open block, among memory blocks, in accordance with another embodiment of the present invention.

FIG. 8 is a block diagram illustrating a memory system in accordance with an embodiment of the present invention.

FIG. 9 is a block diagram illustrating a structure of an erase management component in accordance with an embodiment of the present invention.

FIG. 10 is a schematic diagram illustrating a configuration of a memory device employed in the memory system, such as that shown in FIG. 1.

FIG. 11 is a circuit diagram illustrating a configuration of a memory cell array of a memory block in the memory device, such as that shown in FIG. 1.

FIG. 12 is a block diagram illustrating a structure of a memory device of a memory system in accordance with an embodiment of the present invention.

FIGS. 13 to 21 are diagrams schematically illustrating application examples of the data processing system in accordance with various embodiments of the present invention.

### DETAILED DESCRIPTION

Various embodiments of the present invention will be described below in more detail with reference to the accompanying drawings. The present invention may, however, be embodied in different forms and should not be construed as limited to the embodiments set forth herein. Rather, these embodiments are provided so that this disclosure is thorough and complete and fully conveys the scope of the present invention to those skilled in the art. Throughout the disclosure, like reference numerals refer to like parts throughout the various figures and embodiments of the present invention.

It is noted that reference to “an embodiment,” “another embodiment” or the like does not necessarily mean only one embodiment, and different references to any such phrase are not necessarily to the same embodiment(s).

It will be understood that, although the terms “first” and/or “second” may be used herein to identify various elements, these elements are not limited by these terms. These terms are only used to distinguish one element from another element that otherwise have the same or similar names. For example, a first element in one instance could be termed a second element in another instance, and vice versa, without departing from the teachings of the present disclosure.

It will be understood that when an element is referred to as being “coupled” or “connected” to another element, it can be directly coupled or connected to the other element or one or more intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to” or “directly adjacent to” should be construed in the same way. Communication between two elements, whether directly or indirectly connected/coupled, may be wired or wireless, unless the context indicates otherwise.

The terminology used herein is for the purpose of describing particular embodiments only and is not intended to be limiting. In the present disclosure, the singular forms are intended to include the plural forms as well, unless the context clearly indicates otherwise. It will be further understood that open-ended terms such as “comprise”, “include”, “have”, when used in this specification, specify the presence of stated features, numbers, steps, operations, elements, components, and/or combinations of them but do not preclude the presence or addition of one or more other features, numbers, steps, operations, elements, components, and/or combinations thereof.

The above-described embodiments are merely for the purpose of understanding the present invention, not limiting it. Various modifications of the disclosed embodiments that fall within the spirit and scope of the present disclosure will be apparent to those skilled in the art.

Unless otherwise defined, all terms including technical and scientific terms used herein have the same meaning as commonly understood by one of ordinary skill in the art to which the present disclosure pertains. Unless otherwise defined in the present disclosure, the terms should not be construed as being ideal or excessively formal.

Various embodiments of the present invention will be described in detail now with reference to the attached drawings.

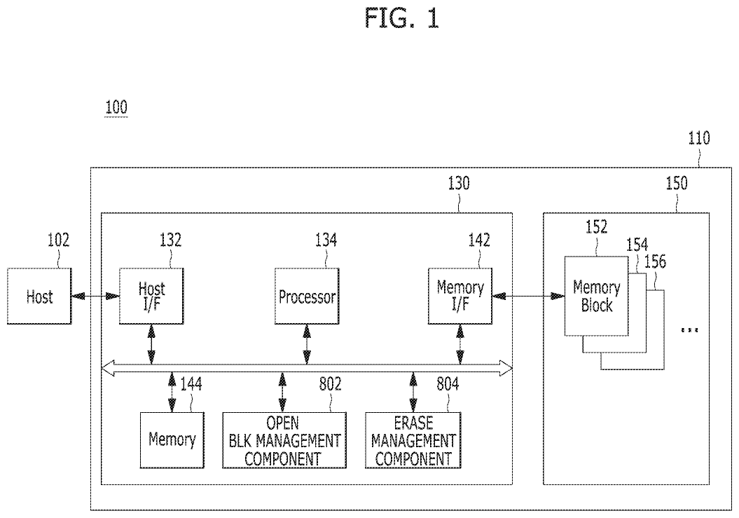

FIG. 1 is a block diagram illustrating a data processing system 100 including a memory system 110 in accordance with an embodiment of the present invention.

Referring to FIG. 1, the data processing system 100 may include a host 102 operatively coupled to the memory system 110.

The host 102 may include any of a variety of portable electronic devices such as a mobile phone, a MP3 player and a laptop computer, or any of a variety of non-portable electronic devices such as a desktop computer, a game machine, a television (TV) and a projector.

The host 102 may include at least one operating system (OS) or a plurality of operating systems. The host 102 may execute an OS to perform an operation corresponding to a user's request on the memory system 110. Here, the host 102 may provide a plurality of commands corresponding to a user's request to the memory system 110. Thus, the memory system 110 may perform certain operations corresponding to the plurality of commands, that is, corresponding to the user's request. The OS may manage and control overall functions and operations of the host 102. The OS may support an operation between the host 102 and a user using the data processing system 100 or the memory system 110.

The memory system 110 may operate or perform a specific function or operation in response to a request from the host 102. Particularly, the memory system 110 may store data to be accessed by the host 102. The memory system 110 may be used as a main memory system or an auxiliary memory system of the host 102. The memory system 110 may be implemented with any of various types of storage devices, which may be electrically coupled with the host 102, according to a protocol of a host interface. Non-limiting examples of the memory system 110 include a solid state drive (SSD), a multi-media card (MMC) and an embedded MMC (eMMC).

The memory system 110 may include various types of storage devices. Non-limiting examples of such storage devices include volatile memory devices such as a dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM), and a flash memory.

The memory system 110 may include a memory device 150 and a controller 130.

The controller 130 and the memory device 150 may be integrated into a single semiconductor device, which may be included in any of the various types of memory systems as described above. For example, the controller 130 and the memory device 150 may be integrated as a single semiconductor device to constitute an SSD, a personal computer memory card international association (PCMCIA) card, a secure digital (SD) card including a mini-SD, a micro-SD and a SDHC, and a universal flash storage (UFS) device. The memory system 110 may be configured as a part of a computer, a smart phone, a portable game player, or one of various components configuring a computing system.

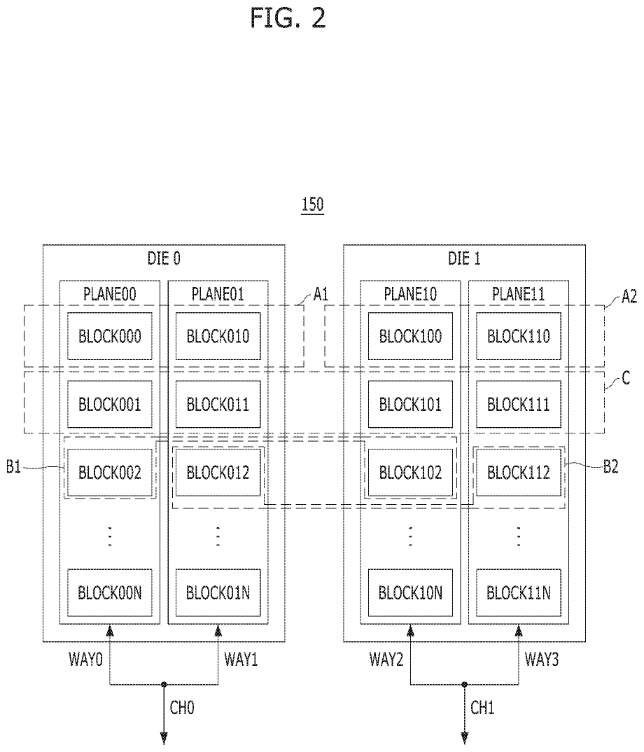

The memory device 150 may be a nonvolatile memory device which may retain stored data even though power is not supplied. The memory device 150 may store data provided from the host 102 through a write operation, and output data stored therein to the host 102 through a read operation. In an embodiment, the memory device 150 may include a plurality of memory dies (as shown in FIG. 2), and each memory die may include a plurality of planes (as shown in FIG. 2). Each plane may include a plurality of memory blocks 152 to 156, each of which may include a plurality of pages, each of which may include a plurality of memory cells coupled to a word line. In an embodiment, the memory device 150 may be a flash memory having a 3-dimensional (3D) stack structure.

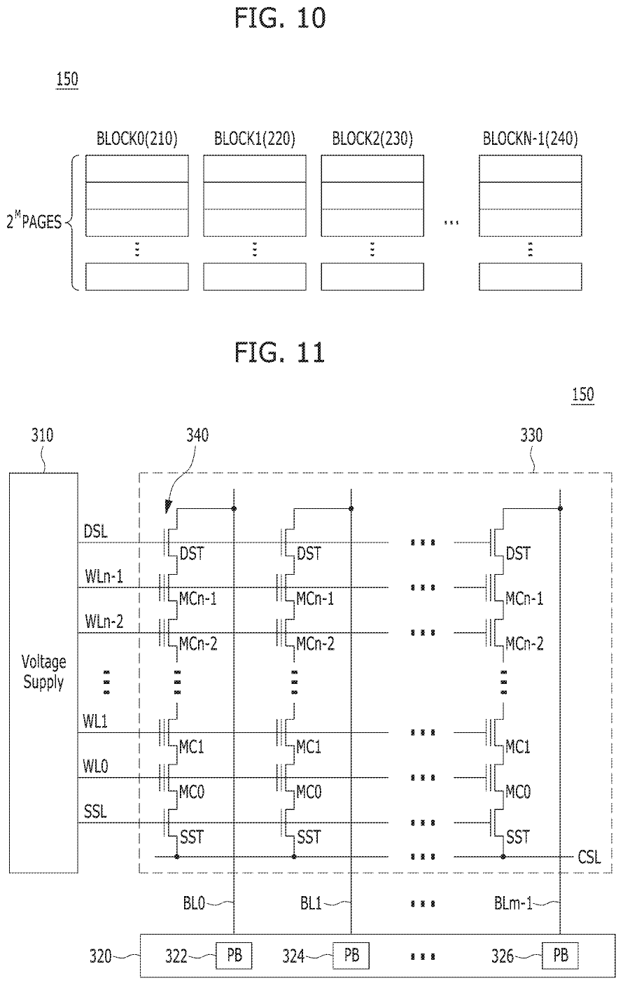

The structure of the memory device 150 and the three-dimensional stack structure of the memory device 150 will be described more in detail below with reference to FIGS. 10 to 12.

The controller 130 may control the memory device 150 in response to a request from the host 102. For example, the controller 130 may provide data read from the memory device 150 to the host 102, and store data provided from the host 102 into the memory device 150. For this operation, the controller 130 may control read, write, program and erase operations of the memory device 150.

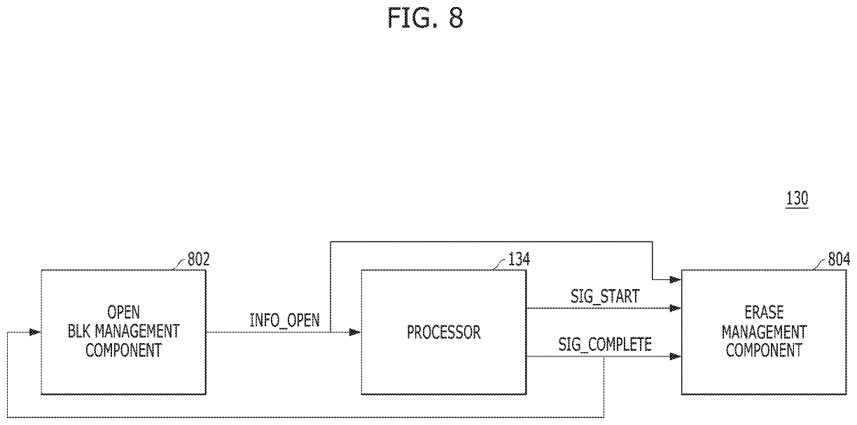

More specifically, the controller 130 may include a host interface (I/F) 132, a processor 134, a memory interface 142, and a memory 144, all operatively coupled or engaged via an internal bus. As described below with reference to FIG. 8, the controller 130 may further include an open block (BLK) management component 802 and an erase management component 804. Each of the open block management component 802 and erase management component 804 may be implemented with an appropriate combination of hardware (e.g., circuitry), software and firmware.

The host interface 132 may process a command and data of the host 102. The host interface 132 may communicate with the host 102 through one or more of various interface protocols such as universal serial bus (USB), multi-media card (MMC), peripheral component interconnect-express (PCI-e or PCIe), small computer system interface (SCSI), serial-attached SCSI (SAS), serial advanced technology attachment (SATA), parallel advanced technology attachment (DATA), enhanced small disk interface (ESDI) and integrated drive electronics (IDE). The host interface 132 may be driven via firmware, that is, a host interface layer (HIL) for exchanging data with the host 102.

The memory interface 142 may serve as a memory or storage interface between the controller 130 and the memory device 150 such that the controller 130 may control the memory device 150 in response to a request from the host 102.

The memory 144 may serve as a working memory of the memory system 110 and the controller 130, and store data for driving the memory system 110 and the controller 130.

The memory 144 may be a volatile memory. For example, the memory 144 may be a static random access memory (SRAM) or dynamic random access memory (DRAM). The memory 144 may be disposed within or external to the controller 130. FIG. 1 shows the memory 144 disposed within the controller 130. In another embodiment, the memory 144 may be an external volatile memory having a memory interface for transferring data between the memory 144 and the controller 130.

As described above, the memory 144 may include a program memory, a data memory, a write buffer/cache, a read buffer/cache, a data buffer/cache and a map buffer/cache to store some data required to perform data write and read operations between the host 102 and the memory device 150 and other data required for the controller 130 and the memory device 150 to perform these operations.

The processor 134 may control overall operations of the memory system 110. The processor 134 may use firmware to control the overall operations of the memory system 110. The firmware may be referred to as flash translation layer (FTL). The processor 134 may be implemented with a microprocessor, a central processing unit (CPU) or other suitable component.

For example, the controller 130 may perform an operation requested by the host 102 in the memory device 150 through the processor 134. Also, the controller 130 may perform a background operation on the memory device 150 through the processor 134. The background operation performed on the memory device 150 may include a garbage collection (GC) operation, a wear-leveling (WL) operation, a map flush operation and a bad block management operation. The garbage collection (GC) operation may include copying and processing data stored in some memory blocks among the memory blocks 152 to 156 of the memory device 150 into other memory blocks. The wear-leveling (WL) operation may include swapping data between select memory blocks of the memory blocks 152 to 156. The map flush operation may include storing the map data stored in the controller 130 in some of the memory blocks 152 to 156. The bad block management operation may include managing bad blocks of the memory device 150, e.g., detecting and processing bad blocks among the memory blocks 152 to 156 in the memory device 150.

FIG. 2 is a diagram illustrating a concept of a super memory block used in a memory system in accordance with an embodiment of the present invention.

FIG. 2 illustrates in detail a die and plane arrangement of the memory device 150 shown in FIG. 1 in accordance with an embodiment of the present invention.

Referring to FIG. 2, the memory device 150 may include a plurality of memory blocks BLOCK000 to BLOCK00N, BLOCK010 to BLOCK01N, BLOCK100 to BLOCK10N and BLOCK110 to BLOCK11N.

In addition, the memory device 150 may include a first memory die DIE0 capable of inputting and outputting data through a zeroth channel CH0 and a second memory die DIE1 capable of inputting and outputting data through a first channel CH1. The zeroth and first channels CH0 and CH1 may input and output data in an interleaving scheme.

The first memory die DIE0 may include a plurality of planes, e.g., PLANE00 and PLANE01 respectively corresponding to a plurality of ways, e.g., WAY0 and WAY1. The ways WAY0 and WAY1 may input and output data in the interleaving scheme by sharing the zeroth channel CH0.

The second memory die DIE1 may include a plurality of planes, e.g., PLANE 10 and PLANE 11 respectively corresponding to a plurality of ways, e.g., WAY2 and WAY3. The ways WAY2 and WAY3 may input and output data in the interleaving scheme by sharing the first channel CH1.

The first plane PLANE00 of the first memory die DIE0 may include a set number of memory blocks BLOCK000 to BLOCK00N among the plurality of memory blocks.

The second plane PLANE01 of the first memory die DIE0 may include a set number of memory blocks BLOCK010 to BLOCK01N among the plurality of memory blocks.

The first plane PLANE10 of the second memory die DIE1 may include a set number of memory blocks BLOCK100 to BLOCK10N among the plurality of memory blocks.

The second plane PLANE11 of the second memory die DIE1 may include a set number of memory blocks BLOCK110 to BLOCK11N among the plurality of memory blocks.

In this manner, the plurality of memory blocks in the memory device 150 may be divided into groups, according to their physical locations and their use of the ways and channels.

In the illustrated embodiment of the present invention, two memory dies are included in the memory device 150, two planes are included in each of the memory dies, and a set number of memory blocks are included in each of the planes, the invention is not limited to this particular configuration or arrangement. In other embodiments, more or less than two memory dies may be included in the memory device 150, more or less than two planes may be included in the respective memory dies, according to system design considerations. Also, the set number of memory blocks included in the respective planes may be also adjusted according to system design considerations.

As an alternative to the location-based memory block division scheme described above, the plurality of memory blocks BLOCK000 to BLOCK00N, BLOCK010 to BLOCK01N, BLOCK100 to BLOCK10N and BLOCK110 to BLOCK11N in the memory device 150, the controller 130 may divide the plurality of memory blocks BLOCK000 to BLOCK00N, BLOCK010 to BLOCK01N, BLOCK100 to BLOCK10N and BLOCK110 to BLOCK11N on a basis of which memory blocks are simultaneously selected and operated. In other words, the controller 130 may manage a plurality of memory blocks which are located in different dies or different planes by grouping memory blocks capable of being selected simultaneously and thereby dividing the grouped memory blocks into super memory blocks.

The simultaneous selection scheme of grouping the memory blocks into super memory blocks by the controller 130 may be performed in various ways according to the system design. Three simultaneous selection schemes will be exemplified as follows.

A first scheme is to group an arbitrary memory block, e.g., BLOCK000 from the first plane PLANE00 and an arbitrary memory block, e.g., BLOCK010 from the second plane PLANE01 of the first memory die DIE0 and manage the grouped memory blocks BLOCK000 and BLOCK010 as a single super memory block A1. When the first scheme is applied to the second memory die DIE1, the controller 130 may group an arbitrary memory block, e.g., BLOCK100 from the first plane PLANE10 and an arbitrary memory block, e.g., BLOCK110 from the second plane PLANE11 of the second memory die DIE1 and manage the grouped memory blocks BLOCK100 and BLOCK110 as a single super memory block A2.

A second scheme is to group an arbitrary memory block, e.g., BLOCK002 from the first plane PLANE00 of the first memory die DIE0 and an arbitrary memory block, e.g., BLOCK102 from the first plane PLANE10 of the second memory die DIE1 and manage the grouped memory blocks BLOCK002 and BLOCK102 as a single super memory block B1. In addition, according to the second way, the controller 130 may group an arbitrary memory block, e.g., BLOCK012 from the second plane PLANE01 of the first memory die DIE0 and an arbitrary memory block, e.g., BLOCK112 from the second plane PLANE11 of the second memory die DIE1 and manage the grouped memory blocks BLOCK012 and BLOCK112 as a single super memory block B2.

A third scheme is to group an arbitrary memory block, e.g., BLOCK001 from the first plane PLANE00 of the first memory die DIE0, an arbitrary memory block, e.g., BLOCK011 from the second plane PLANE01 of the first memory die DIE0, an arbitrary memory block, e.g., BLOCK101 from the first plane PLANE10 of the second memory die DIE1, and an arbitrary memory block, e.g., BLOCK111 from the second plane PLANE11 of the second memory die DIE1 and manage the grouped memory blocks BLOCK001, BLOCK011, BLOCK101 and BLOCK111 as a single super memory block C.

The simultaneously-selectable memory blocks included in the respective super memory blocks may be substantially simultaneously selected by the controller 130 through an interleaving scheme, for example, a channel interleaving scheme, a memory die interleaving scheme, a memory chip interleaving scheme or a way interleaving scheme.

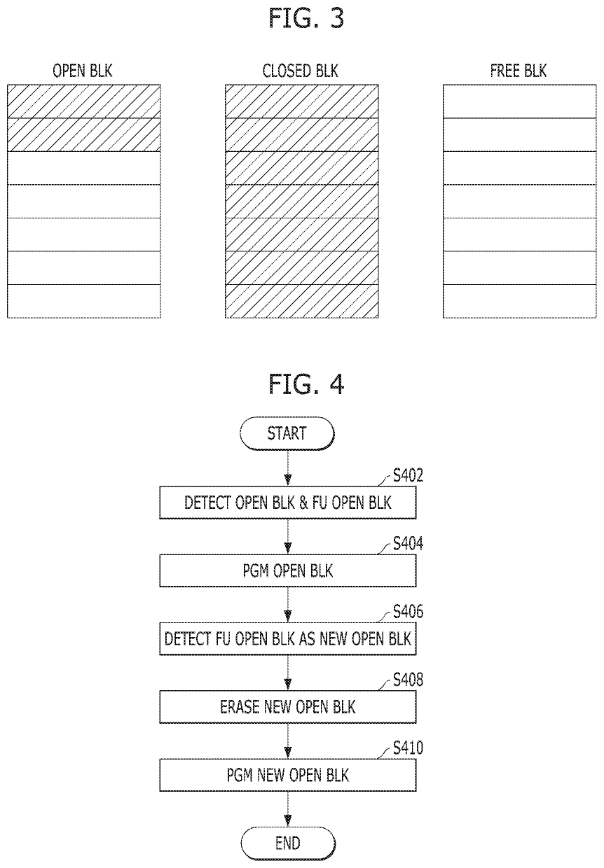

FIG. 3 illustrates a concept of an open block of a plurality of memory blocks.

Referring to FIG. 3, the memory device 150 of FIG. 1 may include a plurality of memory blocks, and the controller 130 may divide the memory blocks into open blocks OPEN BLK and closed blocks CLOSED BLK. For example, the controller 130 may detect or select open blocks OPEN BLK from a group of open block candidates which includes memory blocks with invalid pages or free blocks FREE BLK with empty pages. When the controller 130 detects a memory block filled with invalid pages as the open block OPEN BLK, the controller 130 may control the memory device 150 to perform an erase operation on the detected open block OPEN BLK. The open block OPEN BLK may include one or more empty pages. When the controller 130 performs a program operation according to a host request or performs a program operation according to a background operation, the controller 130 may control the memory device 150 to program an empty page of the open block OPEN BLK with program data. The controller 130 may control the memory device 150 to program all empty pages of the open block OPEN BLK with program data and then convert the open block OPEN BLK into a closed block CLOSED BLK. Therefore, the closed block CLOSED BLK may not include any empty pages.

As described above, when the controller 130 detects a memory block which is not a free block as an open block OPEN BLK among the open block candidates, the controller 130 may control the memory device 150 to perform an erase operation on the detected open block OPEN BLK before programming such open block OPEN BLK with program data. Therefore, total time taken for performing a program operation on the open block OPEN BLK may include the time taken for the memory device 150 to perform an erase operation on the open block OPEN BLK in addition to the time taken for the memory device 150 to program the open block OPEN BLK with the program data. Therefore, as the time taken for performing the erase operation on the open block OPEN BLK increases, the total time taken for performing the program operation on the open block OPEN BLK increases as well.

FIG. 4 is a flowchart illustrating a conventional program operation.

Referring to FIG. 4, at step S402, a controller detects an open block OPEN BLK and a subsequent open block FU OPEN BLK. The controller detects the open block OPEN BLK among the open block candidates and control a memory device to program the open block OPEN BLK with program data. The controller converts the detected open block OPEN BLK into a closed block CLOSED BLK and then detects the subsequent open block FU OPEN BLK as a target block where the program data is to be programmed. In other words, the subsequent open block FU OPEN BLK is detected as a new open block NEW OPEN BLK after a program operation is completed for all the empty pages in the detected open block OPEN BLK.

At step S404, the controller controls the memory device to perform a program (PGM) operation on the open block OPEN BLK detected at the step S402. When the detected open block OPEN BLK s not a free block FREE BLK, the controller controls the memory device to perform an erase operation on the open block OPEN BLK and program an empty page of the open block OPEN BLK with the program data. When the detected open block OPEN BLK is a free block FREE BLK, the controller controls the memory device not to perform the erase operation but to directly program an empty page of the open block OPEN BLK with the program data.

At step S406, when a program operation for the open block OPEN BLK performed at the step S404 is completed, the controller converts the open block OPEN BLK into a closed block CLOSED BLK. Further, the controller detects the subsequent open block FU OPEN BLK detected at the step S402 as a new open block NEW OPEN BLK. In other words, after the controller detects the memory block to be detected as a new open block NEW OPEN BLK as the subsequent open block FU OPEN BLK at the step S402, the controller detects the subsequent open block FU OPEN BLK as the new open block NEW OPEN BLK at the step S406.

At step S408, the controller controls the memory device to perform an erase operation on the new open block NEW OPEN BLK detected at the step S406. The controller converts all pages in the detected new open block NEW OPEN BLK into empty pages according to the erase operation. As long as the new open block NEW OPEN BLK is not a free block FREE BLK, the controller has to perform the erase operation before programming the new open block NEW OPEN BLK with the program data.

At step S410, the controller controls the memory device to program the new open block NEW OPEN BLK with the program data only after the erase operation performed at the step S408 is completed. That is, the controller controls the memory device to necessarily perform an erase operation on the new open block NEW OPEN BLK, which is detected at the step S408, after detecting the subsequent open block FU OPEN BLK as a new open block NEW OPEN BLK at the step S406. Therefore, the total time required to complete the operation of programming the new open block NEW OPEN BLK with the program data always includes the time taken for performing an erase operation on the new open block NEW OPEN BLK. Therefore, as the time required to perform the erase operation on the new open block NEW OPEN BLK increases, the total time required to program the new open block NEW OPEN BLK with the program data increases correspondingly.

According to an embodiment of the present invention, the controller 130 may control the memory device 150 to perform an erase operation on the subsequent open block FU OPEN BLK while performing a program operation on an open block OPEN BLK. Therefore, after the subsequent open block FU OPEN BLK is detected as a new open block NEW OPEN BLK, the time required to convert the new open block NEW OPEN BLK into a free block may be shortened. As a result, t is possible to shorten the total time required to program the new open block NEW OPEN BLK with the program data.

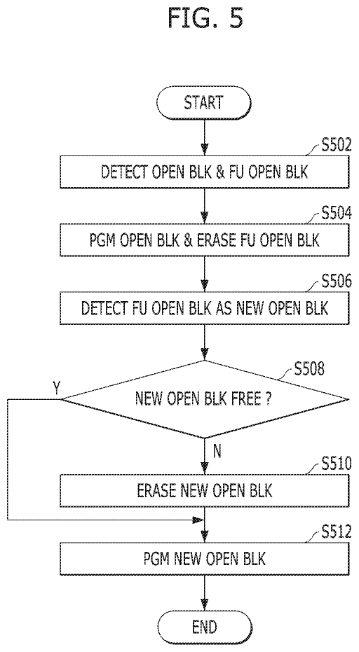

FIG. 5 is a flowchart illustrating an operation of a memory system (e.g., the memory system 110 of FIG. 1) in accordance with an embodiment of the present invention.

Referring to FIG. 5, at step S502, the controller 130 of FIG. 1 may detect an open block OPEN BLK and a subsequent open block FU OPEN BLK. The controller 130 may detect the open block OPEN BLK and the subsequent open block FU OPEN BLK among the open block candidates including free blocks FREE BLK and memory blocks with invalid pages. The controller 130 may detect a memory block to be programmed with the current program data as the open block OPEN BLK. After the program operation performed on the detected open block OPEN BLK is completed, a new memory block to be programmed with the subsequent program data may be detected as the subsequent open block FU OPEN BLK. In other words, the subsequent open block FU OPEN BLK may be a memory block to be detected as a new open block NEW OPEN BLK after a program operation, performed on all empty pages of the open block OPEN BLK, is completed.

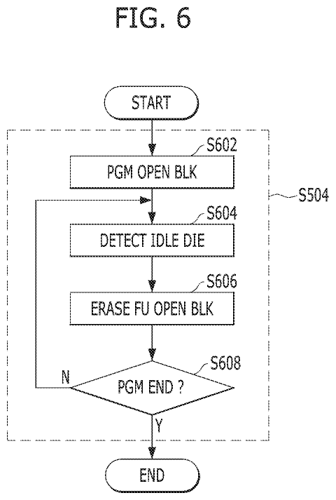

At step S504, the controller 130 may control the memory device 150 to perform an erase operation on the subsequent open block FU OPEN BLK while programming (PGM) the open block OPEN BLK detected at the step S502 with the program data at the same time. When a die including the subsequent open block FU OPEN BLK is idle, the controller 130 may control the memory device 150 to perform an erase operation onto the subsequent open block FU OPEN BLK while programming the open block BLK with the program data. An idle die may mean a die which is in an idle state in which no operation is performed. The erase operation for the subsequent open block FU OPEN BLK is described in detail below with reference to FIG. 6.

FIG. 6 is a flowchart illustrating an erase operation performed on a subsequent open block, for example, step S504 of FIG. 5.

Referring to FIG. 6, at step S602, the controller 130 may control the memory device 150 to perform a program (PGM) operation of programming the detected open block OPEN BLK with program data. The controller 130 may control the memory device 150 to program an empty page included in the open block OPEN BLK with the program data.

At step S604, the controller 130 may detect an idle die during the program operation performed on the open block OPEN BLK. Such an idle die may be present in the memory device 150 when the memory device 150 does not operate in a full interleaving manner in which the memory device 150 programs all dies in an interleaving method. The controller 130 may be able to detect an idle die among the dies by checking whether the dies in the memory device 150 operate or not during the program operation performed on the open block OPEN BLK.

At step S606, when the die including the subsequent open block FU OPEN BLK is the idle die detected at the step S604, the controller 130 may control the memory device 150 to perform an erase operation on the subsequent open block FU OPEN BLK, When the program operation performed on the open block OPEN BLK is not completed (‘N’ at the step S608), the controller 130 may return to the steps S604 and S606 to repeat the idle die detection operation and the subsequent open block erase operation and convert the subsequent open block FU OPEN BLK into a free block FREE BLK while the program operation is being performed onto the open block OPEN

According to an embodiment of the present invention, when the die including the subsequent open block FU OPEN BLK is detected to be idle, the controller 130 may control the memory device 150 to perform an erase operation on the subsequent open block FU OPEN BLK, not after the program operation performed on the open block OPEN BLK is completed, but while the program operation is being performed on the open block OPEN BLK. Therefore, when the program operation performed on the open block OPEN BLK is completed, the subsequent open block FU OPEN BLK may be detected as a new open block NEW OPEN BLK, and then the new open block NEW OPEN BLK may be immediately programmed with program data without performing an erase operation on the new open block NEW OPEN BLK, thus improving the program speed and reducing the time of the overall programming operation.

Referring back to FIG. 5, at step S506, the controller 130 may detect the subsequent open block FU OPEN BLK as a new open block NEW OPEN BLK after the program operation performed onto the open block OPEN BLK is completed. The controller 130 may convert the open block OPEN BLK where the program operation is completed into a closed block CLOSED BLK.

At step S508, the controller 130 may check whether or not the new open block NEW OPEN BLK is a free block FREE BLK. When the new open block NEW OPEN BLK is a free block FREE BLK (‘Y’ at the step S508), at step S512, the controller 130 may immediately program the new open block NEW OPEN BLK with program data without an erase operation. When the new open block NEW OPEN BLK is not a free block FREE BLK (‘N’ at the step S508), the controller 130 may control the memory device 150 to perform an erase operation on the new open block NEW OPEN BLK at step S510. Then, the controller 130 may perform a program operation on the new open block NEW OPEN BLK at step S512.

According to an embodiment of the present invention, while a program operation is being performed on an open block OPEN BLK, if the die including the next open block FU OPEN BLK is idle, an erase operation may be performed on the subsequent open block FU OPEN BLK while the program operation is being performed on the open block OPEN BLK without having to perform such an erase operation on the subsequent open block FU OPEN BLK at a different time. Therefore, after the program operation performed on the open block OPEN BLK is completed, the controller 130 may immediately program the new open block NEW OPEN BLK with the program data without performing an erase operation on the new open block NEW OPEN BLK. For this reason, whenever a program operation needs to be performed on a new open block NEW OPEN BLK, the memory device 150 may not need to perform an erase operation ahead of the program operation. As a result, the program speed for the memory device 150 may be improved.

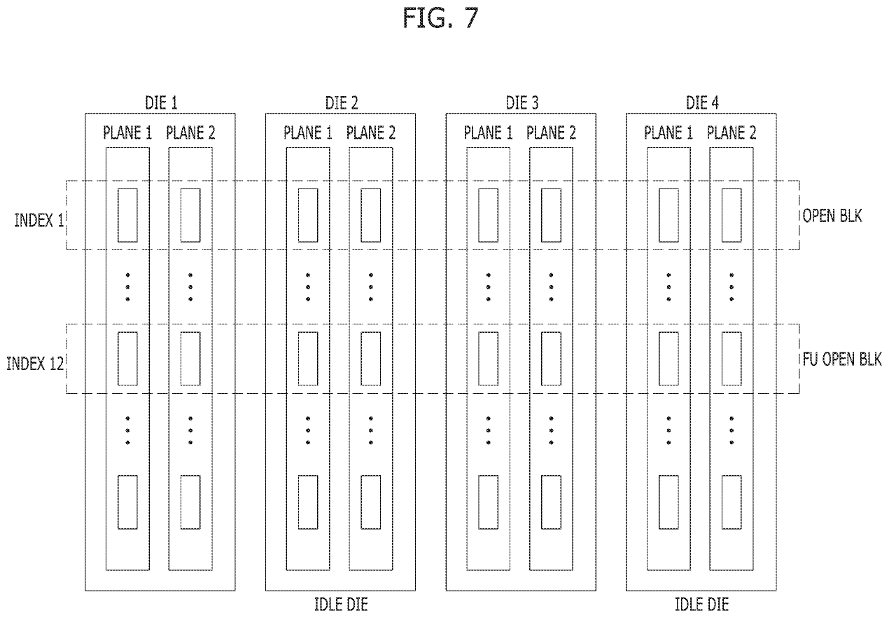

FIG. 7 illustrates an erase operation performed onto a subsequent open block in accordance with another embodiment of the present invention.

According to another embodiment of the present invention, the controller 130 may control the memory device 150 to perform a program operation and an erase operation on the basis of a super block, described earlier with reference to FIG. 2. FIG. 7 shows an example where an open block OPEN BLK and a subsequent open block FU OPEN BLK form a super block. By way of example, the memory device 150 includes four dies, i.e., first to fourth dies DIE 1 to DIE 4, each of which includes two planes, i.e., first and second planes PLANE1 and PLANE2.

The controller 130 may form one super block of memory blocks sharing the same index, among the memory blocks in first and second planes PLANE1 and PLANE2. For example, an open block OPEN BLK may be a super block formed of memory blocks sharing a first index INDEX 1 among the memory blocks in the first and second planes PLANE 1 and PLANE 2. The subsequent open block FU OPEN BLK may be a super block formed of memory blocks sharing a 12^{th} index INDEX 12, among the memory blocks in the first and second planes PLANE1 and PLANE2.

The controller 130 may detect an idle die during a program operation performed on the open block OPEN BLK. The controller 130 may control the memory device 150 to perform an erase operation on the memory blocks in the detected idle die among the memory blocks that are candidates for the subsequent open block FU OPEN BLK. For example, when the second die DIE2 and the fourth die DIE4 are idle, the controller 130 may control the memory device 150 to perform an erase operation on the memory blocks in the second die DIE2 and the fourth die DIE4 among the memory blocks that are candidates for the subsequent open block FU OPEN BLK while a program operation is being performed on the open block OPEN BLK.

According to another embodiment of the present invention, the controller 130 may detect a subsequent open block FU OPEN BLK as a new open block NEW OPEN BLK after a program operation performed on an open block OPEN BLK is completed. The memory blocks included in the second die DIE2 and the fourth die DIE4 of the subsequent open block FU OPEN BLK may be already converted to free blocks FREE BLK, while a program operation is being performed onto the open block OPEN BLK. Therefore, the controller 130 may control the memory device 150 to perform a program operation, after an erase operation is performed, only on the memory blocks included in the remaining first die DIE1 and the third die DIE3, not on any memory blocks in the second die DIE2 and the fourth die DIE4.

In a case where the new open block NEW OPEN BLK is a super block described with reference to FIG. 2, since the new open block NEW OPEN BLK includes a plurality of memory blocks, it may take a lot of time to perform an erase operation on all the memory blocks included in the new open block NEW OPEN BLK. According to another embodiment of the present invention, when the dies in the subsequent open block FU OPEN BLK are idle while a program operation is performed on the open block, the controller 130 may control the memory device 150 to perform an erase operation, in advance, on the memory blocks in the idle dies. Therefore, after detecting the subsequent open block FU OPEN BLK as a new open block NEW OPEN BLK, the controller 130 may control the memory device 150 to immediately perform a program operation on the new open block NEW OPEN BLK without performing an erase operation.

FIG. 8 is a block diagram illustrating a memory system, e.g., the memory system 110 of FIG. 1, in accordance with an embodiment of the present invention. FIG. 8 shows only select structure in the data processing system 100 of FIG. 1 that is related to the description below.

Referring to FIG. 8, the controller 130 may further include an open block (BLK) management component 802 and an erase management component 804.

The open block management component 802 may detect an open block OPEN BLK and a subsequent open block FU OPEN BLK. The open block management component 802 may detect a memory block to be programmed with the current program data as the open block OPEN BLK. After the program operation performed on the detected open block OPEN BLK is completed, the open block management component 802 may detect a new memory block to be programmed with the program data as the subsequent open block FU OPEN BLK. The open block management component 802 may provide the processor 134 and the erase management component 804 with information INFO_OPEN about the detected open block OPEN BLK and the subsequent open block FU OPEN BLK.

The processor 134 may control the memory device 150 to program the program data into the detected open block OPEN BLK based on the provided information INFO_OPEN about the open block OPEN BLK and the subsequent open block FU OPEN BLK. The processor 134 may provide the erase management component 804 with a start signal SIG_START when the program operation performed on the open block OPEN BLK starts and a complete signal SIG_COMPLETE when the program operation performed on the open block OPEN BLK is completed. As described later, the processor 134 may also provide the open block management component 802 with the complete signal SIG_COMPLETE upon completion of the program operation performed on the open block OPEN BLK.

The erase management component 804 may control the memory device 150 to perform an erase operation on the subsequent open block FU OPEN BLK based on the provided start signal SIG_START. The erase management component 804 may detect idle dies from when the start signal SIG_START is provided until the complete signal SIG_COMPLETE is provided. According to an embodiment of the present invention, when the die including the subsequent open block FU OPEN BLK is idle, the erase management component 804 may control the memory device 150 to perform an erase operation on the subsequent open block FU OPEN BLK while the processor 134 controls the memory device 150 to program the open block OPEN BLK with the program data.

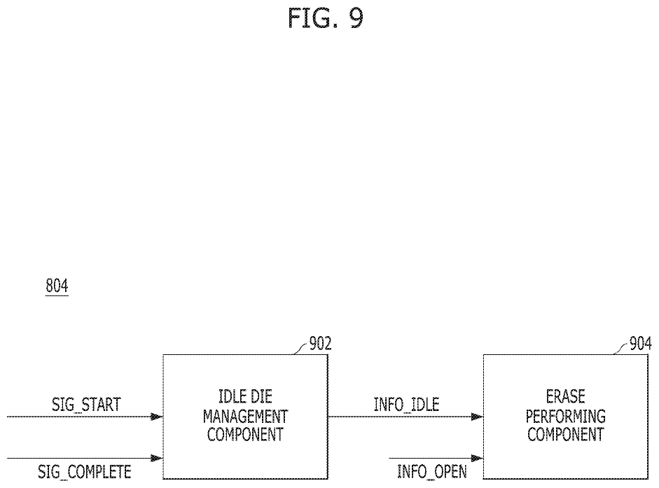

FIG. 9 is a block diagram illustrating a structure of erase management component, i.e., the erase management component 804 of FIG. 8, in accordance with an embodiment of the present invention.

Referring to FIG. 9, the erase management component 804 may include an idle die management component 902 and an erase performing component 904.

The idle die management component 902 may detect an idle die while the memory device 150 is performing a program operation on the open block OPEN BLK based on the start signal SIG_START provided from the processor 134. Only some of the dies in the memory device 150 may be in an idle state. For example, when the memory device 150 does not operate in a full interleaving method in which a program operation is performed on all the dies in an interleaving method, there may be an idle die in the memory device 150. The idle die management component 902 may detect the idle die by distinguishing busy dies and idle dies from each other while the memory device 150 is performing the program operation on the open block OPEN BLK, The idle die management component 902 may provide the erase performing component 904 with information INFO_IDLE about the idle die.

When the die including the subsequent open block FU OPEN BLK is the detected idle die, the erase performing component 904 may control the memory device 150 to perform an erase operation on the subsequent open block FU OPEN BLK based on the provided idle die information INFO_IDLE. According to an embodiment of the present invention, when the die including the subsequent open block FU OPEN BLK is an idle die, the erase performing component 904 may control the memory device 150 to perform an erase operation on the subsequent open block FU OPEN BLK, not after the program operation performed on the open block OPEN BLK is completed, but while performing the program operation on the open block OPEN BLK.

Referring back to FIG. 8, the processor 134 may provide the open block management component 802 with the complete signal SIG_COMPLETE upon completion of the program operation performed on the open block OPEN BLK. The open block management component 802 may detect a subsequent open block FU OPEN BLK as a new open block NEW OPEN BLK based on the provided complete signal SIG_COMPLETE. The open block management component 802 may provide the processor 134 with information INFO_OPEN about the new open block NEW OPEN BLK. When the new open block NEW OPEN BLK is a free block, the processor 134 may control the memory device 150 to directly perform a program operation on the new open block NEW OPEN BLK without performing an erase operation on the new open block NEW OPEN BLK.

According to embodiments of the present invention, when the program operation performed on the open block OPEN BLK is completed, it is possible to immediately program the new open block NEW OPEN BLK with program data without performing an erase operation on the new open block NEW OPEN BLK, after detecting the subsequent open block FU OPEN BLK as the new open block NEW OPEN BLK. As a result, the program speed may be improved and the time for programming shortened.

Now, referring to FIGS. 10 to 12, a memory device 150 in a memory system, e.g., the memory system 110, in accordance with an embodiment of the present invention is described in more detail.

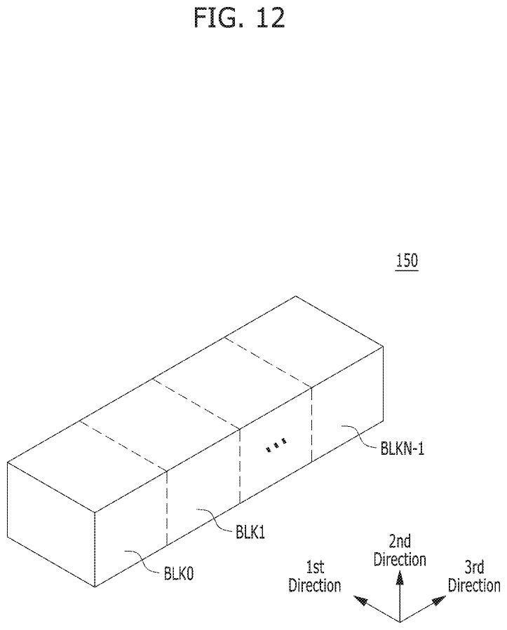

FIG. 10 is a schematic diagram illustrating the memory device 150. FIG. 11 is a circuit diagram illustrating a configuration of a memory cell array of a memory block 330 in the memory device 150. FIG. 12 is a schematic diagram illustrating a three-dimensional (3D) structure of the memory device 150.

Referring to FIG. 10, the memory device 150 may include a plurality of memory blocks BLOCK0 to BLOCKN−1, where N is an integer greater than 1. Each of the blocks BLOCK0 to BLOCKN−1 may include a plurality of pages, for example, 2^{M} or M pages, the number of which may vary according to circuit design, M being an integer greater than 1. Each of the pages may include a plurality of memory cells that are coupled to a plurality of word lines WL.

Also, memory cells in the respective memory blocks BLOCK0 to BLOCKN−1 may be one or more of a single level cell (SLC) memory block having cells each storing 1-bit data or a multi-level cell (MLC) memory block having cells each storing 2-bit data. Hence, the memory device 150 may include SLC memory blocks or MLC memory blocks, depending on the number of bits which can be expressed or stored in each of the memory cells in the memory blocks. The SLC memory blocks may include a plurality of pages which are embodied by memory cells, each storing one-bit data. The SLC memory blocks may generally have higher data computing performance and higher durability than the MLC memory blocks. The MLC memory blocks may include a plurality of pages which are embodied by memory cells each storing multi-bit data (for example, 2 or more bits). The MLC memory blocks may generally have larger data storage space, that is, higher integration density, than the SLC memory blocks. In another embodiment, the memory device 150 may include a plurality of triple level cell (TLC) memory blocks. In yet another embodiment, the memory device 150 may include a plurality of quadruple level cell (QLC) memory blocks. The TLC memory blocks may include a plurality of pages which are embodied by memory cells each capable of storing 3-bit data. The QLC memory blocks may include a plurality of pages which are embodied by memory cells each capable of storing 4-bit data.

Instead of a nonvolatile memory, the memory device 150 may be implemented by any of a phase change random access memory (PCRAM), a resistive random access memory (RRAM or ReRAM), a ferroelectrics random access memory (FRAM), and a spin transfer torque magnetic random access memory (STT-RAM or STT-MRAM).

The memory blocks 210, 220, 230, 240 may store the data received from the host 102 through a program operation, and may transfer data stored therein to the host 102 through a read operation.

Referring to FIG. 11, the memory block 330, which is representative of any of the memory blocks 152 to 156, may include a plurality of cell strings 340 coupled to a plurality of corresponding bit lines BL0 to BLm−1. Each of the cell string 340 of each column may include one or more drain select transistors DST and one or more source select transistors SST. Between the drain and source select transistors DST and SST, a plurality of memory cells MC0 to MCn−1 may be coupled in series. In an embodiment, each of the memory cell transistors MC0 to MCn−1 may be embodied by an MLC capable of storing data information of a plurality of bits. Each of the cell strings 340 may be electrically coupled to a corresponding bit line among the plurality of bit lines BL0 to BLm−1. For example, as illustrated in FIG. 11, the first cell string is coupled to the first bit line BL0, and the last cell string is coupled to the last bit line BLm−1.

Although FIG. 11 illustrates NAND flash memory cells, the present invention is not limited thereto. It is noted that the memory cells may be NOR flash memory cells, or hybrid flash memory cells including two or more kinds of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply 310 which generates different word line voltages including a program voltage, a read voltage, and a pass voltage to supply to the word lines according to an operation mode. The voltage generation operation of the voltage supply 310 may be controlled by a control circuit (not illustrated). Under the control of the control circuit, the voltage supply 310 may select at least one of the memory blocks (or sectors) of the memory cell array, select at least one of the word lines of the selected memory block, and provide the word line voltages to the selected word line(s) and the unselected word lines as may be needed.

The memory device 150 may include a read/write circuit 320 which is controlled by the control circuit. During a verification and normal read operation, the read/write circuit 320 may operate as a sense amplifier for sensing and amplifying data read from the memory cell array. During a program operation, the read/write circuit 320 may operate as a write driver for supplying a voltage or a current to bit lines according to data to be stored in the memory cell array. During a program operation, the read/write circuit 320 may receive, from a buffer (not illustrated), data to be stored into the memory cell array, and drive bit lines according to the received data. The read/write circuit 320 may include a plurality of page buffers 322 to 326 respectively corresponding to columns (or bit lines) or column pairs (or bit line pairs). Each of the page buffers 322 to 326 may include a plurality of latches (not illustrated).

The memory device 150 may be embodied by a two-dimensional (2D) or three-dimensional (3D) memory device. Particularly, as illustrated in FIG. 12, the memory device 150 may be embodied by a nonvolatile memory device having a 3D stack structure. When the memory device 150 has a 3D structure, the memory device 150 may include a plurality of memory blocks BLK0 to BLKN−1. FIG. 12 is a block diagram illustrating the memory blocks 152, 154 and 156 of the memory device 150 shown in FIG. 1. Each of the memory blocks 152, 154 and 156 may be realized in a 3D structure (or vertical structure). For example, the memory blocks 152, 154 and 156 may collectively form a three-dimensional structure with dimensions extending in first to third mutually orthogonal directions, e.g., an x-axis direction, a y-axis direction, and a z-axis direction.

Each memory block 330 included in the memory device 150 may include a plurality of NAND strings NS that are extended in the second direction, and a plurality of NAND strings NS that are extended in the first direction and the third direction. Each of the NAND strings NS may be coupled to a bit line BL, at least one string selection line SSL, at least one ground selection line GSL, a plurality of word lines WL, at least one dummy word line DWL, and a common source line CSL, and each of the NAND strings NS may include a plurality of transistor structures TS.

In short, each memory block 330 may be coupled to a plurality of bit lines BL, a plurality of string selection lines SSL, a plurality of ground selection lines GSL, a plurality of word lines WL, a plurality of dummy word lines DWL, and a plurality of common source lines CSL. Each memory block 330 may include a plurality of NAND strings NS. Also, in each memory block 330, one bit line BL may be coupled to a plurality of NAND strings NS to realize a plurality of transistors in one NAND string NS. Also, a string selection transistor SST of each NAND string NS may be coupled to a corresponding bit line BL. A ground selection transistor GST of each NAND string NS may be coupled to a common source line CSL. Herein, memory cells MC may be provided between the string selection transistor SST and the ground selection transistor GST of each NAND string NS. In other words, a plurality of memory cells may be realized in each memory block 330 of the memory device 150.

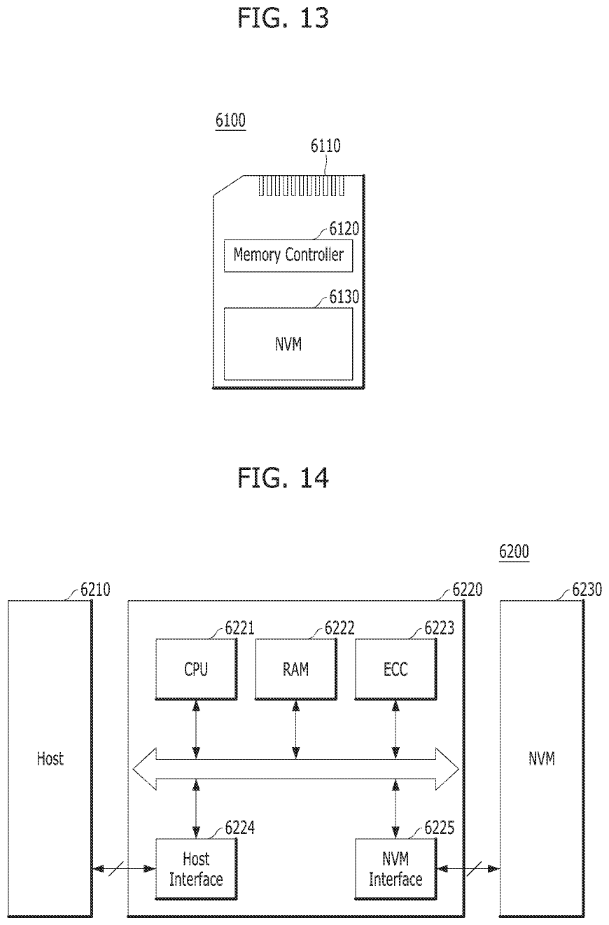

Embodiments of a data processing system and electronic devices, to which the memory system 110 including the memory device 150 and the controller 130 described above, may be applied are described in detail with reference to FIGS. 13 to 21.

FIG. 13 is a diagram schematically illustrating another example of the data processing system including the memory system in accordance with an embodiment. FIG. 13 schematically illustrates a memory card system 6100 to which the memory system may be applied.

Referring to FIG. 13, the memory card system 6100 may include a memory controller 6120, a memory device 6130 and a connector 6110.

More specifically, the memory controller 6120 may be electrically connected to, and configured to access, the memory device 6130 embodied by a nonvolatile memory. For example, the memory controller 6120 may be configured to control read, write, erase and background operations of the memory device 6130. The memory controller 6120 may be configured to provide an interface between the memory device 6130 and a host, and to use firmware for controlling the memory device 6130. That is, the memory controller 6120 may correspond to the controller 130 of the memory system 110 described with reference to FIG. 1, and the memory device 6130 may correspond to the memory device 150 of the memory system 110 described with reference to FIG. 1.

Thus, the memory controller 6120 may include a random access memory (RAM), a processor, a host interface, a memory interface and an error correction component.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA (SATA), Parallel-ATA (PATA), small computer system interface (SCSI), enhanced small disk interface (EDSI), Integrated Drive Electronics (IDE), Firewire, universal flash storage (UFS), wireless fidelity (Wi-Fi or WiFi) and Bluetooth. Thus, the memory system and the data processing system may be applied to wired/wireless electronic devices including specific mobile electronic devices.

The memory device 6130 may be implemented by a nonvolatile memory (NVM). For example, the memory device 6130 may be implemented by any of various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM).

The memory controller 6120 and the memory device 6130 may be integrated into a single semiconductor device to form a solid-state drive (SSD). Also, the memory controller 6120 and the memory device 6130 may be so integrated to form a memory card such as a PC card (e.g., Personal Computer Memory Card International Association (PCMCIA)), a compact flash (CF) card, a smart media card (e.g., a SM and a SMC), a memory stick, a multimedia card (e.g., a MMC, a RS-MMC, a MMCmicro and an eMMC), a secure digital (SD) card (e.g., a SD, a miniSD, a microSD and a SDHC), and/or a universal flash storage (UFS).

FIG. 14 is a diagram schematically illustrating another example of a data processing system 6200 including the memory system in accordance with an embodiment.

Referring to FIG. 14, the data processing system 6200 may include a memory device 6230 having one or more nonvolatile memories (NVMs) and a memory controller 6220 for controlling the memory device 6230. The data processing system 6200 illustrated in FIG. 14 may serve as a storage medium such as a memory card (CF, SD, micro-SD or the like) or USB device, as described with reference to FIG. 1. The memory device 6230 may correspond to the memory device 150 in the memory system 110 illustrated in FIG. 1, and the memory controller 6220 may correspond to the controller 130 in the memory system 110 illustrated in FIG. 1.

The memory controller 6220 may control a read, write or erase operation on the memory device 6230 in response to a request of the host 6210. The memory controller 6220 may include one or more central processing units (CPUs) 6221, a buffer memory such as a random access memory (RAM) 6222, an error correction code (ECC) circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or vice versa. When the RAM 6222 is used as a cache memory, the RAM 6222 may assist the low-speed memory device 6230 to operate at high speed.

The ECC circuit 6223 may generate an error correction code (ECC) for correcting a failed bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. The ECC circuit 6223 may correct an error using the parity bit. The ECC circuit 6223 may correct an error using Low Density Parity Check (LDDC) code, Bose-Chaudhri-Hocquenghem (BCH) code, turbo code, Reed-Solomon code, convolution code, Recursive Systematic Code (RSC) or coded modulation such as Trellis-Coded Modulation (TCM) or Block coded modulation (BCM).

The memory controller 6220 may exchange data with the host 6210 through the host interface 6224. The memory controller 6220 may exchange data with the memory device 6230 through the NVM interface 6225. The host interface 6224 may be connected to the host 6210 through a parallel advanced technology attachment (DATA) bus, a serial advanced technology attachment (SATA) bus, a small computer system interface (SCSI), a universal serial bus (USB), a peripheral component interconnect-express (PCIe) or a NAND interface. The memory controller 6220 may have a wireless communication function with a mobile communication protocol such as wireless fidelity (WiFi) or Long Term Evolution (LTE). The memory controller 6220 may be connected to an external device, for example, the host 6210 or another external device, and then transmit and/or receive data to/from the external device. In particular, as the memory controller 6220 is configured to communicate with the external device according to one or more of various communication protocols, the memory system and the data processing system may be applied to wired/wireless electronic devices, particularly a mobile electronic device.

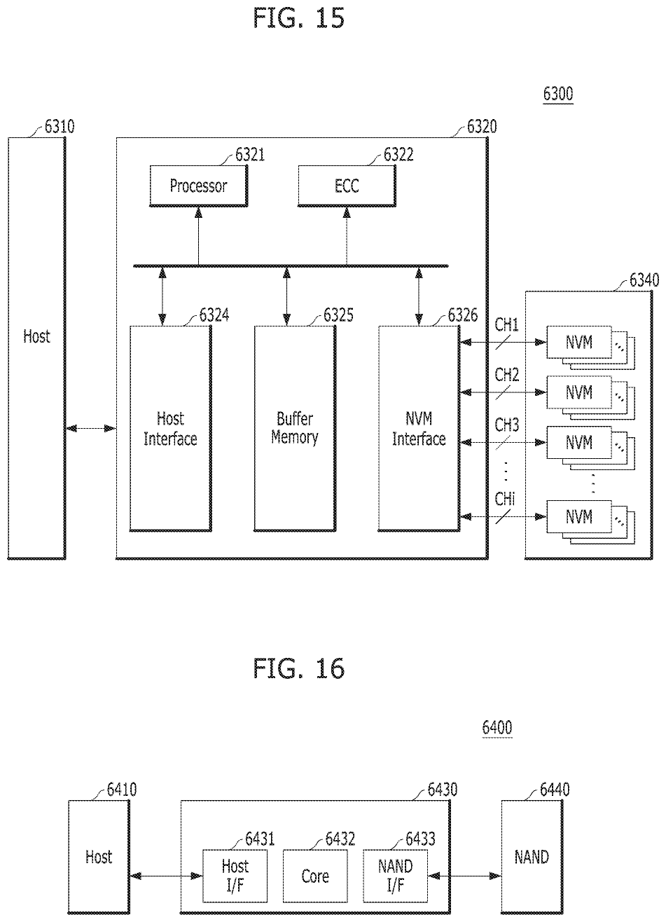

FIG. 15 is a diagram schematically illustrating another example of the data processing system including the memory system in accordance with an embodiment. FIG. 15 schematically illustrates a solid state drive (SSD) 6300 to which the memory system may be applied.

Referring to FIG. 15, the SSD 6300 may include a controller 6320 and a memory device 6340 including a plurality of nonvolatile memories (NVMs). The controller 6320 may correspond to the controller 130 in the memory system 110 of FIG. 1, and the memory device 6340 may correspond to the memory device 150 in the memory system of FIG. 1.

More specifically, the controller 6320 may be connected to the memory device 6340 through a plurality of channels CH1 to CHi. The controller 6320 may include one or more processors 6321, an error correction code (ECC) circuit 6322, a host interface 6324, a buffer memory 6325 and a memory interface, for example, a nonvolatile memory interface 6326.

The buffer memory 6325 may temporarily store data provided from the host 6310 or data provided from a plurality of flash memories NVM included in the memory device 6340. Further, the buffer memory 6325 may temporarily store meta data of the plurality of flash memories NVM, for example, map data including a mapping table. The buffer memory 6325 may be embodied by any of a variety of volatile memories such as a dynamic random access memory (DRAM), a synchronous DRAM (SDRAM), a double data rate (DDR) SDRAM, a low power DDR (LPDDR) SDRAM and a graphics RAM (GRAM) or nonvolatile memories such as a ferroelectric RAM (FRAM), a resistive RAM (RRAM or ReRAM), a spin-transfer torque magnetic RAM (STT-MRAM) and a phase-change RAM (PRAM). FIG. 15 illustrates that the buffer memory 6325 is embodied in the controller 6320. However, the buffer memory 6325 may be external to the controller 6320.

The ECC circuit 6322 may calculate an ECC value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310. The nonvolatile memory interface 6326 may provide an interface function with the memory device 6340 connected through the plurality of channels.

Furthermore, a plurality of SSDs 6300 to which the memory system 110 of FIG. 1 may be applied may be provided to embody a data processing system, for example, a Redundant Array of Independent Disks (RAID) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 16 is a diagram schematically illustrating another example of the data processing system including the memory system in accordance with an embodiment. FIG. 16 schematically illustrates an embedded Multi-Media Card (eMMC) 6400 to which the memory system may be applied.

Referring to FIG. 16, the eMMC 6400 may include a controller 6430 and a memory device 6440 embodied by one or more NAND flash memories. The controller 6430 may correspond to the controller 130 in the memory system 110 of FIG. 1. The memory device 6440 may correspond to the memory device 150 in the memory system 110 of FIG. 1.

More specifically, the controller 6430 may be connected to the memory device 6440 through a plurality of channels. The controller 6430 may include a host interface 6431, one or more cores 6432, and a memory interface, for example, a NAND interface 6433.

The core 6432 may control overall operations of the eMMC 6400. The host interface 6431 may provide an interface function between the controller 6430 and the host 6410. The NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, Ultra High Speed (UHS)-I and UHS-II interface.

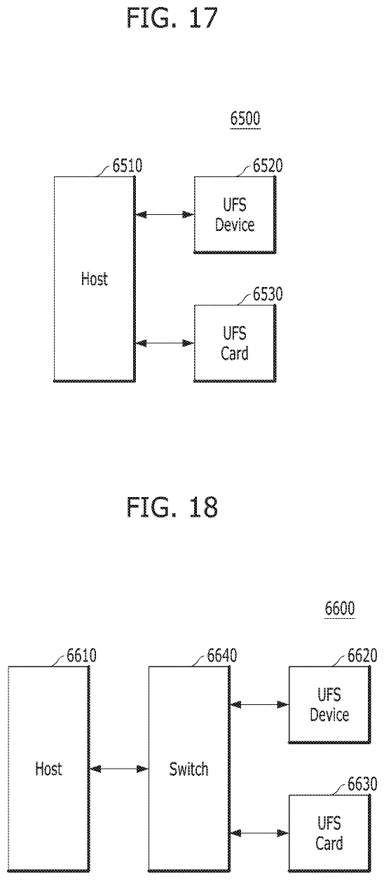

FIGS. 17 to 20 are diagrams schematically illustrating other examples of the data processing system including the memory system in accordance with embodiments. FIGS. 17 to 20 schematically illustrate Universal Flash Storage (UFS) systems 6500, 6600, 6700 and 6800, to which the memory system may be applied.

Referring to FIGS. 17 to 20, the UFS systems 6500, 6600, 6700, 6800 may include hosts 6510, 6610, 6710, 6810, UFS devices 6520, 6620, 6720, 6820 and UFS cards 6530, 6630, 6730, 6830, respectively. The hosts 6510, 6610, 6710, 6810 may serve as application processors of wired/wireless electronic devices, particularly mobile electronic devices, the UFS devices 6520, 6620, 6720, 6820 may serve as embedded UFS devices, and the UFS cards 6530, 6630, 6730, 6830 may serve as external embedded UFS devices or removable UFS cards.

The hosts 6510, 6610, 6710, 6810, the UFS devices 6520, 6620, 6720, 6820 and the UFS cards 6530, 6630, 6730, 6830 in the respective UFS systems 6500, 6600, 6700, 6800 may communicate with external devices, for example, wired/wireless electronic devices or particularly mobile electronic devices through UFS protocols, and the UFS devices 6520, 6620, 6720, 6820 and the UFS cards 6530, 6630, 6730, 6830 may be embodied by the memory system 110 illustrated in FIG. 1. For example, in the UFS systems 6500, 6600, 6700, 6800, the UFS devices 6520, 6620, 6720, 6820 may be embodied in the form of the data processing system 6200, the SSD 6300 or the eMMC 6400 described with reference to FIGS. 14 to 16, and the UFS cards 6530, 6630, 6730, 6830 may be embodied in the form of the memory card system 6100 described with reference to FIG. 13.

Furthermore, in the UFS systems 6500, 6600, 6700, 6800, the hosts 6510, 6610, 6710, 6810, the UFS devices 6520, 6620, 6720, 6820 and the UFS cards 6530, 6630, 6730, 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720, 6820 and the UFS cards 6530, 6630, 6730, 6830 may communicate with each other through any of various protocols other than the UFS protocol, for example, universal storage bus (USB) Flash Drives (UFDs), a multi-media card (MMC), a secure digital (SD), a mini-SD, and a micro-SD.

In the UFS system 6500 illustrated in FIG. 17, each of the host 6510, the UFS device 6520 and the UFS card 6530 may include UniPro. The host 6510 may perform a switching operation to communicate with the UFS device 6520 and the UFS card 6530. In particular, the host 6510 may communicate with the UFS device 6520 or the UFS card 6530 through link layer switching, for example, L3 switching at the UniPro. The UFS device 6520 and the UFS card 6530 may communicate with each other through link layer switching at the UniPro of the host 6510. In the illustrated embodiment, one UFS device 6520 and one UFS card 6530 are connected to the host 6510. However, in another embodiment, a plurality of UFS devices and UFS cards may be connected in parallel or in the form of a star to the host 6410. A star formation is an arrangement in which a single device is coupled with plural devices for centralized operation. A plurality of UFS cards may be connected in parallel or in the form of a star to the UFS device 6520 or connected in series or in the form of a chain to the UFS device 6520.

In the UFS system 6600 illustrated in FIG. 18, each of the host 6610, the UFS device 6620 and the UFS card 6630 may include UniPro. The host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the illustrated embodiment, one UFS device 6620 and one UFS card 6630 are connected to the switching module 6640. However, in another embodiment, a plurality of UFS devices and UFS cards may be connected in parallel or in the form of a star to the switching module 6640. A plurality of UFS cards may be connected in series or in the form of a chain to the UFS device 6620.

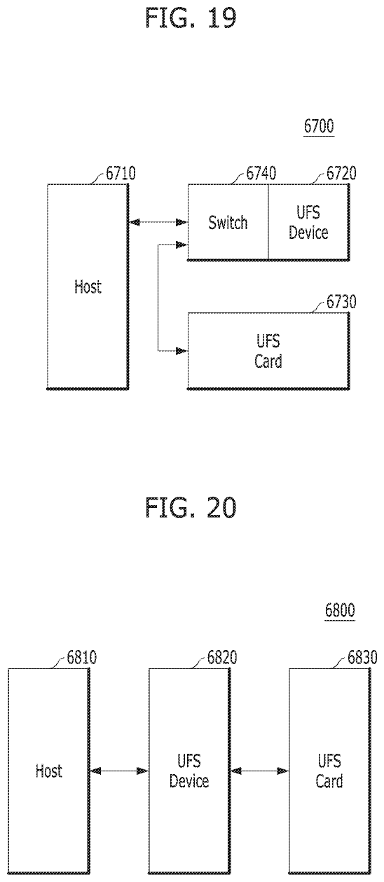

In the UFS system 6700 illustrated in FIG. 19, each of the host 6710, the UFS device 6720 and the UFS card 6730 may include UniPro. The host 6710 may communicate with the UFS device 6720 or the UFS card 6730 through a switching module 6740 performing a switching operation, for example, through the switching module 6740 which performs link layer switching at the UniPro, for example, L3 switching. The UFS device 6720 and the UFS card 6730 may communicate with each other through link layer switching of the switching module 6740 at the UniPro. The switching module 6740 may be integrated as one module with the UFS device 6720 inside or outside the UFS device 6720. In the illustrated embodiment, one UFS device 6720 and one UFS card 6730 are connected to the switching module 6740. However, in another embodiment, a plurality of modules, each including the switching module 6740 and the UFS device 6720, may be connected in parallel or in the form of a star to the host 6710. In another example, a plurality of modules may be connected in series or in the form of a chain to each other. Furthermore, a plurality of UFS cards may be connected in parallel or in the form of a star to the UFS device 6720.

In the UFS system 6800 illustrated in FIG. 20, each of the host 6810, the UFS device 6820 and the UFS card 6830 may include M-PHY and UniPro. The UFS device 6820 may perform a switching operation to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target Identifier (ID) switching operation. The host 6810 and the UFS card 6830 may communicate with each other through target ID switching between the M-PHY and UniPro modules of the UFS device 6820. In the illustrated embodiment, one UFS device 6820 is connected to the host 6810 and one UFS card 6830 is connected to the UFS device 6820. However, in another embodiment, a plurality of UFS devices may be connected in parallel or in the form of a star to the host 6810, or connected in series or in the form of a chain to the host 6810. A plurality of UFS cards may be connected in parallel or in the form of a star to the UFS device 6820, or connected in series or in the form of a chain to the UFS device 6820.

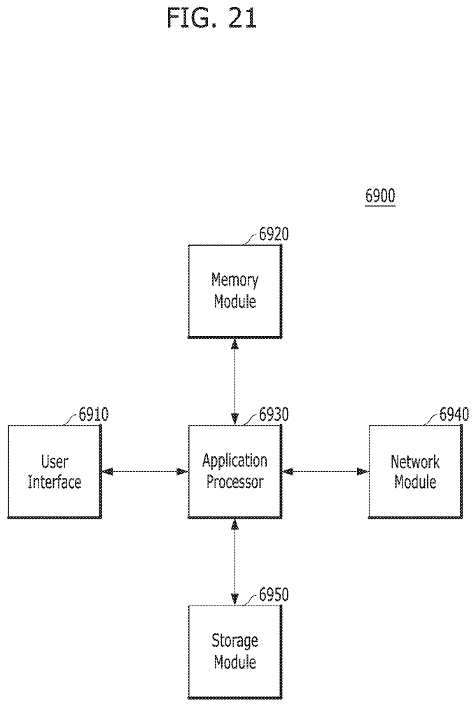

FIG. 21 is a diagram schematically illustrating another example of the data processing system including the memory system in accordance with an embodiment of the present invention. FIG. 21 is a diagram schematically illustrating a user system 6900 to which the memory system may be applied.

Referring to FIG. 21, the user system 6900 may include a user interface 6910, a memory module 6920, an application processor 6930, a network module 6940, and a storage module 6950.

More specifically, the application processor 6930 may drive components in the user system 6900, for example, an operating system (OS), and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile random access memory (RAM) such as a dynamic RAM (DRAM), a synchronous DRAM (SDRAM), a double data rate (DDR) SDRAM, a DDR2 SDRAM, a DDR3 SDRAM, a low power DDR (LPDDR) SDARM, a LPDDR3 SDRAM or a LPDDR4 SDRAM or a nonvolatile RAM such as a phase-change RAM (PRAM), a resistive RAM (ReRAM), a magneto-resistive RAM (MRAM) or a ferroelectric RAM (FRAM). For example, the application processor 6930 and the memory module 6920 may be packaged and mounted, based on Package on Package (PoP).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices, particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, a NOR flash and a 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, an eMMC and an UFS as described above with reference to FIGS. 15 to 20.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIG. 1 is applied to a mobile electronic device of the user system 6900, the application processor 6930 may control overall operations of the mobile electronic device, and the network module 6940 may serve as a communication module for controlling wired/wireless communication with an external device. The user interface 6910 may display data processed by the processor 6930 on a display/touch module of the mobile electronic device, or support a function of receiving data from the touch panel.

According to embodiments of the present invention, the memory system may shorten a time taken for performing a program operation by previously performing an erase operation on a subsequent open block while a program operation is performed on an open block.

While the present invention has been illustrated and described with respect to the specific embodiments, it will be apparent to those skilled in the art in light of the present disclosure that various changes and modifications may be made without departing from the spirit and scope of the invention as defined in the following claims.

What is claimed is:

1. A memory system, comprising:
a memory device including a plurality of dies; and
a controller suitable for performing
an idle die detection operation including detecting an idle die among the plurality of dies while performing a program operation on an open block;
a subsequent open block erase operation including performing an erase operation on a subsequent open block, when a die including the subsequent open block is the detected idle die; and
an open block program operation including detecting the subsequent open block as a new open block and performing the program operation on the new open block after the program operation performed on the open block is completed.

2. The memory system of claim 1, wherein the controller simultaneously detects the open block and the subsequent open block from open block candidates.

3. The memory system of claim 2, wherein the open block candidates are memory blocks with free blocks or invalid pages.

4. The memory system of claim 1, wherein the open block and the subsequent open block are a super open block and a subsequent super open block, respectively.

5. The memory system of claim 4, wherein the controller detects the idle die while the program operation is performed on the super open block.

6. The memory system of claim 5, wherein the controller performs the erase operation on memory blocks included in the detected idle die among memory blocks included in the subsequent super open block.

7. The memory system of claim 6, wherein the controller detects free blocks in the subsequent super open block, after the program operation performed on the super open block is completed.

8. The memory system of claim 7, wherein the controller performs the erase operation on remaining memory blocks excluding the detected free blocks among the memory blocks in the subsequent super open block.

9. The memory system of claim 8, wherein the controller detects the subsequent super open block as a new super open block and performs the program operation on the newly detected super open block.

10. The memory system of claim 1, wherein the idle die is a die in a state of not performing any operation.

11. A method for operating a memory system, comprising:
detecting an idle die among a plurality of dies while performing a program operation on an open block;
performing an erase operation on a subsequent open block, when a die including the subsequent open block is the detected idle die;
detecting the subsequent open block as a new open block; and
performing the program operation on the new open block after the program operation performed on the open block is completed.

12. The method of claim 11, further comprising:
simultaneously detecting the open block and the subsequent open block from open block candidates.

13. The method of claim 12, wherein the open block candidates are memory blocks filled with free blocks or invalid pages.

14. The method of claim 11, wherein the open block and the subsequent open block are a super open block and a subsequent super open block, respectively.

15. The method of claim 14, wherein the detecting of the idle die while performing the program operation on the open block includes
detecting the idle die while performing the program operation on the super open block.

16. The method of claim 15, wherein the performing of the erase operation onto the subsequent open block includes
performing the erase operation on memory blocks in the detected idle die among memory blocks in the subsequent super open block.

17. The method of claim 16, further comprising:
detecting free blocks in the subsequent super open block, after the program operation performed on the super open block is completed.

18. The method of claim 17, wherein the detecting of the subsequent open block as the new open block and the performing of the program operation on the new open block after the program operation performed on the open block is completed includes
performing the erase operation on remaining memory blocks excluding the detected free blocks among the memory blocks included in the subsequent super open block.

19. The method of claim 18, wherein the detecting of the subsequent open block as the new open block and the performing of the program operation on the new open block after the program operation performed on the open block is completed includes
detecting the subsequent super open block as a new super open block and performing the program operation on the newly detected super open block.

20. The method of claim 11, wherein the idle die is a die in a state of not performing any operation.
